(19) United States
(12) Patent Application Publication
(10) Pub. No.: US 2011/0247749 A1
(43) Pub. Date: Oct. 13, 2011

(54) PROCESS FOR COATING A FOAMED COATING MATERIAL ON A CONTAINER OR THE LIKE

(75) Inventors: CHING-WEN CHANG, Taichung (TW); HUNG-YING SU, Taoyuan County (TW)

(73) Assignee: RICH CUP BIO-CHEMICAL TECHNOLOGY CO., LTD., Taichung (TW)

(21) Appl. No.: 12/782,686

(22) Filed: May 18, 2010

(30) Foreign Application Priority Data
Apr. 13, 2010 (TW) 099111472

(51) Int. Cl. B32B 37/15; B05D 5/00

(52) U.S. Cl. 156/244.11; 427/256

(57) ABSTRACT

A process for coating a foamed coating material on a container or the like mainly includes preparing a coating material by heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder, coating such coating material on a surface of a container and then heating the container to foam the coated material. The foamed coating material is therefore provides the container with heat insulation property.

### BACKGROUND OF THE INVENTION

1. Field of the Invention

The present invention relates to a process for coating a foamed coating material on a container or the like.

2. Description of the Prior Art

A conventional container, in consideration of a cost and a purpose, is generally a paper-made or plastics-made container, such as a paper-made or plastics-made cup, bowl, and dish, or a filling container made of this material, such as a packaging container, a heat preservation container, and a lunch box. An existing paper-made container is provided with a single layer that cannot preserve and insulate heat. The container may be provided with two layers with a partition, the cost is, however, extremely high and the cost efficiency is not satisfying since the container is designed for one-time usage.

For heat insulation purpose, the existing paper-made cup is held with an additional plastic cup supporter. However, the addition of the plastic cup supporter is in conflict to the original design intention of the one-time-usage paper-made cup since the cup supporter has to be recycled and stored after the paper-made cup is thrown.

### SUMMARY OF THE INVENTION

The main object of the present invention is to provide a process for coating a foamed coating material on a container or the like.

To achieve the above object, the process of the present invention includes the following steps:

(a) heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder to form a coating material, each thermo-expandable microcapsule consisting of a thermoplastic polymer shell and a low-boiling-point solvent wrapped by the thermoplastic polymer shell;

(b) coating the coating material on at least a part of an area specified on a continuous paper reel or a non-continuous paper sheet making up the container, or on at least a part of an area specified on an outer surface of the container by a coating machine;

(c) heating the coated continuous paper reel, the coated non-continuous paper sheet or the coated container to a boiling point of the low-boiling-point solvent so that the solvent vaporizing to balloon the thermoplastic polymer shell, whereby the coating material is foamed and integrally attached on the coated continuous paper reel, the coated non-continuous paper sheet or the coated container.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a flow chart of a process of the present invention;

FIG. 2 is a drawing showing a continuous paper reel of the present invention;

FIG. 3 is a drawing showing a non-continuous paper sheet of the present invention;

FIG. 4 is a drawing showing a container of the present invention;

FIG. 5 is a drawing showing a container with a foamed coating material of the present invention;

FIG. 6A is a profile showing a container with a foamed coating material of the present invention;

FIG. 6B is a profile showing a container with a foamed coating material of the present invention;

FIG. 6C is a profile showing a container with a foamed coating material of the present invention;

FIG. 7A is a profile showing a thermo-expandable microcapsule of the present invention;

FIG. 7B is a profile showing a thermo-expandable microcapsule during foaming of the present invention.

### DETAILED DESCRIPTION OF THE PREFERRED EMBODIMENTS

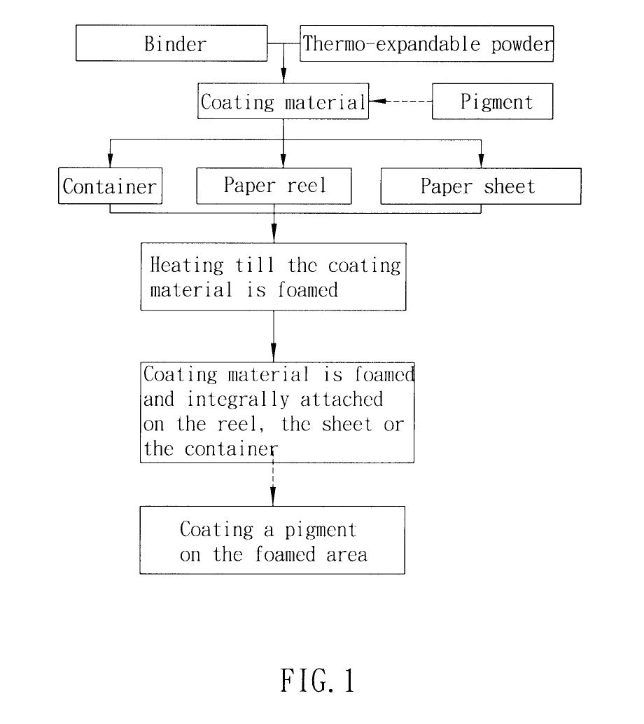

Please refer to FIG. 1. A process for coating a foamed coating material on a container or the like of the present invention includes the following steps:

(a) Heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder to form a coating material. Each thereto-expandable microcapsule consists of a thermoplastic polymer shell and a low-boiling-point solvent wrapped by the thermoplastic polymer shell. The binder is selected from a group consisting of ethylene vinyl acetate resin, polyurethane resin, polyacrylic acid resin, poly lactic acid, amorphous poly-alpha-olefins and a mixture thereof. The coating material may be further mixed with other additives such as plasticizer (e.g. polybutene), petroleums, auxiliary binding agent (e.g. rosin resin, terpene resin and its derivatives, aromatic petroleum resin or aliphatic petroleum resin), filler (e.g. calcium carbonate, titanium dioxide or kaolin) or antiager in order to adjust its properties.

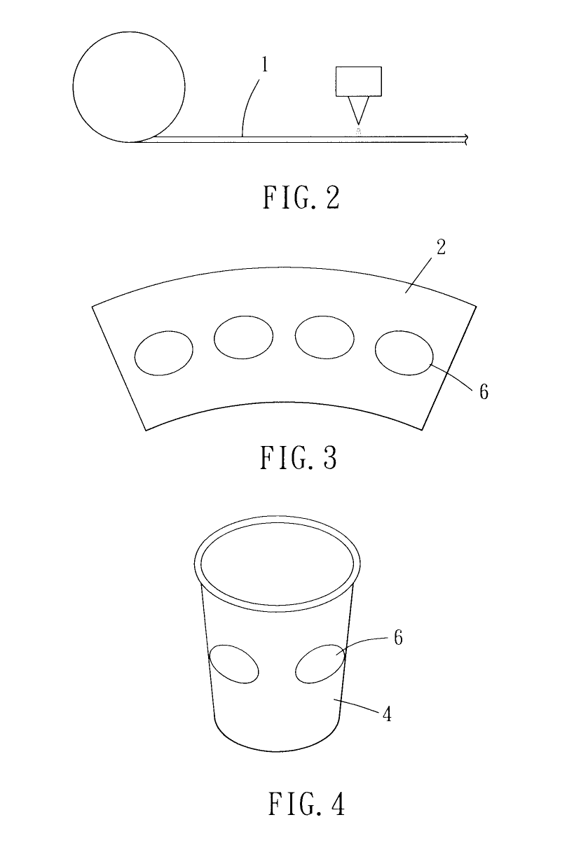

(b) Coating the coating material on at least a part of an area specified on a continuous paper reel or a non-continuous paper sheet making up the container, or on at least a part of an area specified on an outer surface of the container by a coating machine. The continuous paper reel 1 is a reel of paper sheet, as shown in FIG. 2. The non-continuous paper sheet 2 is cut into a predetermined shape, as shown in FIG. 3. The non-continuous paper sheet 2 may be cut from the continuous paper reel 1 and may be further formed into a container 4, as shown in FIG. 4. The coating material is coated on the area in the manner of spraying, extruding, drenching, printing or other process. The area to be coated is preferably a portion of a container where the user holds.

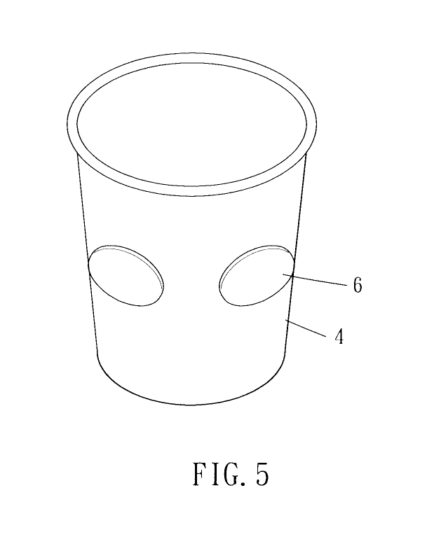

(c) Heating the coated continuous paper reel, the coated non-continuous paper sheet or the coated container to a boiling point of the low-boiling-point solvent so that the solvent vaporizing to balloon the thermoplastic polymer shell. Whereby, the coated material is foamed and integrally attached on the coated continuous paper reel, the coated non-continuous paper sheet or the coated container, as shown in FIG. 5.

In another embodiment of the present invention, the coating material can be heated at the time it is applied on the area. The process of the present embodiment includes the following steps:

(a) Heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder to form a coating material. Each thermo-expandable microcapsule consists of a thermoplastic polymer shell and a low-boiling-point solvent wrapped by the thermoplastic polymer shell. The binder is selected from a group consisting of ethylene vinyl acetate resin, polyurethane resin, polyacrylic acid resin, poly lactic acid, amorphous poly-alpha-olefins and a mixture thereof. The coating material may be further mixed with other additives such as plasticizer (e.g. polybutene), petroleums, auxiliary binding agent (e.g. rosin resin, terpene resin and its derivatives, aromatic petroleum resin or aliphatic petroleum resin), filler (e.g. calcium carbonate, titanium dioxide or kaolin) or antiager in order to adjust its properties.

(b) Coating the coating material on at least a part of an area specified on a continuous paper reel or a non-continuous paper sheet making up the container, or on at least a part of an area specified on an outer surface of the container by a coating machine. The continuous paper reel 1 is a reel of paper sheet, as shown in FIG. 2. The non-continuous paper sheet 2 is cut into a predetermined shape, as shown in FIG. 3. The non-continuous paper sheet 2 may be cut from the continuous paper reel 1 and may be further formed into a container 4, as shown in FIG. 4. The coating material is coated on the area in the manner of spraying, extruding, drenching, printing or other process. The area to be coated is preferably a portion of a container where the user holds. In addition, the coating machine further heats the coated continuous paper reel, the coated non-continuous paper sheet or the coated container to a boiling point of the low-boiling-point solvent so that the solvent vaporizes to balloon the thermoplastic polymer shell at the time the area is coated by the coating material. Whereby the coating material is foamed and integrally attached on the coated continuous paper reel, the coated non-continuous paper sheet or the coated container.

Preferably, the coating machine includes at least one spraying head to spray the coating material on the area, and the spraying head is adapted to heat the coating material to a boiling point of the low-boiling-point solvent so that the solvent can vaporize. That is, the coating and foaming of the coating material is done at the same time.

In yet another embodiment of the present invention, the coated container can be cooled down first for the storage purpose, and thus can be further heated to foam when needed. The process of the present embodiment includes the following steps:

(a) Heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder to form a coating material. Each thermo-expandable microcapsule consists of a thermoplastic polymer shell and a low-boiling-point solvent wrapped by the thermoplastic polymer shell.

(b) Coating the coating material on at least a part of an area specified on a continuous paper reel or a non-continuous paper sheet making up the container, or on at least a part of an area specified on an outer surface of the container by a coating machine.

(c) Cooled down the coated continuous paper reel, the coated non-continuous paper sheet or the coated container to a room temperature for a storage purpose.

(d) Heating the coated continuous paper reel, the coated non-continuous paper sheet or the coated container to a soften point of the binder so that the binder having slightly molecular flowability.

(e) Further heating the coated continuous paper reel, the coated non-continuous paper sheet or the coated container to a boiling point of the low-boiling-point solvent so that the low-boiling-point solvent vaporizing to balloon the thermoplastic polymer shell. Whereby the coating material is foamed and integrally attached on the coated continuous paper reel, the coated non-continuous paper sheet or the coated container.

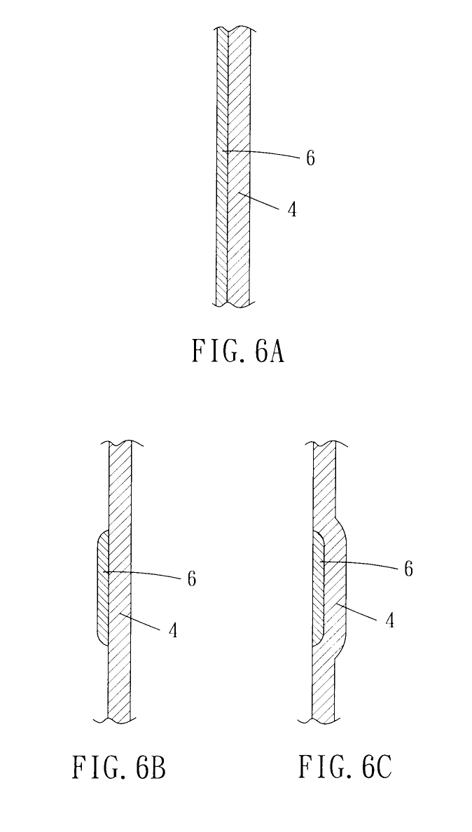

The coating material 6 can be applied on the entire surface of the reel, the sheet or the container 4, thus the coating material is foamed as shown in FIG. 6A. Or, the coating material can be applied on only a part of the surface of the reel, the sheet or the container, and the foamed coating material 6 is more protrusive than the other uncoated surface of the reel, the sheet or the container 4, as shown in FIG. 6B. As such, a 3D pattern is obtained. In addition, the area to be coated may be more concave than the other area on the reel, the sheet or the container, and the coating material 6 is then heated to foam, as shown in FIG. 6C. Preferably, the foamed coating material 6 is flush with the other uncoated area of the outer surface. The foamed coating material provides the container with heat insulation property.

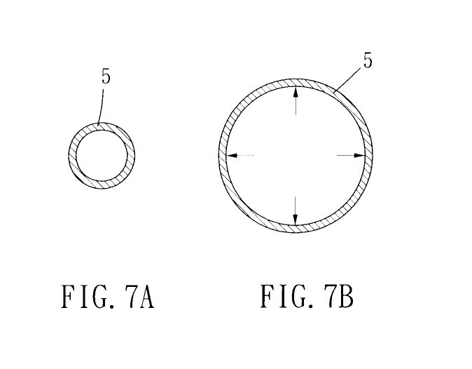

As shown in FIG. 7A, the low-boiling-point solvent is wrapped by the thermoplastic polymer shell 5. When the coating material is heated to reach the boiling point of the solvent, the solvent starts to vaporize and balloon the thermoplastic polymer shell 5 as shown in FIG. 7B. The volume of the expanded thermo-expandable microcapsule can reach 20-50 times that of the un-expanded thermo-expandable microcapsule, thus the thickness of the foamed coating material is expected to be 5-15 times that of the un-foamed coating material. Due to the binder being pre-softened before the thermo-expandable microcapsules starts to foam, the slightly-flowable binder can, therefore, fill the micro gaps formed between the microcapsules. Since each of the expanded thermo-expandable microcapsules is a closed cell, and since the micro gaps between the microcapsules are filled by the slightly-flowable binder, the outer surface of the foamed coating material will be smoother than a conventional foaming material, and the foamed coating material will be watertight. It is to be noted that the coated reel, sheet or container is heated to reach the soften point of the binder first and then is further heated to the boiling point of the low-boiling-point solvent, i.e. the boiling point of the low-boiling-point solvent is higher than the soften point of the binder. If the boiling point of the solvent were lower than the soften point of the binder, the thermo-expandable microcapsules would start foaming when the binder is still coagulated, thus the expansion of the microcapsules would be limited, and the foamed coating material might have leaks because the binder is non-flowable to fill the gaps between the microcapsules. Also note that the term “low-boiling-point” indicates that the solvent has a boiling point at which a paper-made container would not have deformed seriously. And preferably, the heating temperature in step (c) and step (d) falls within a range of 80-160 degrees Celsius.

For aesthetic or advertisement purpose, the foaming area may be further coated with a pigment layer to form patterns or messages. The pigment layer may be applied on the foaming area by conventional method such as printing, spraying or rolling. In addition, the coating material itself may also be mixed with a pigment. As such, the foamed coating material will look colorful and even have patterns. It is noted that since the outer surface of the foamed coating material is smooth, the pigment layer can be applied thereon without difficulty, and the patterns will not be vague.

What is claimed is:

1. A process for coating a foamed coating material on a container or the like, comprising the following steps:
(a) heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder to form a coating material, each thermo-expandable microcapsule consisting of a thermoplastic polymer shell and a low-boiling-point solvent wrapped by the thermoplastic polymer shell;
(b) coating the coating material on at least a part of an area specified on a continuous paper reel or a non-continuous paper sheet making up the container, or on at least a part of an area specified on an outer surface of the container by a coating machine;
(c) heating the coated continuous paper reel, the coated non-continuous paper sheet or the coated container to a boiling point of the low-boiling-point solvent so that the solvent vaporizing to balloon the thermoplastic polymer shell, whereby the coating material is foamed and integrally attached on the coated continuous paper reel, the coated non-continuous paper sheet or the coated container.

2. The process of claim 1, wherein the binder is selected from a group consisting of ethylene vinyl acetate resin, polyurethane resin, polyacrylic acid resin, poly lactic acid, amorphous poly-alpha-olefins and a mixture thereof.

3. The process of claim 1, wherein the coating material is coated on the area in a manner of spraying, extruding, drenching or printing.

4. A process for coating a foamed coating material on a container or the like, comprising the following steps:
(a) heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder to form a coating material, each thermo-expandable microcapsule consisting of a thermoplastic polymer shell and a low-boiling-point solvent wrapped by the thermoplastic polymer shell;
(b) coating the coating material on at least a part of an area specified on a continuous paper reel or a non-continuous paper sheet making up the container, or on at least a part of an area specified on an outer surface of the container by a coating machine, the coating machine further heating the coated continuous paper reel, the coated non-continuous paper sheet or the coated container to a boiling point of the low-boiling-point solvent so that the solvent vaporizing to balloon the thermoplastic polymer shell, whereby the coating material is foamed and integrally attached on the coated continuous paper reel, the coated non-continuous paper sheet or the coated container.

5. The process of claim 4, wherein the binder is selected from a group consisting of ethylene vinyl acetate resin, polyurethane resin, polyacrylic acid resin, poly lactic acid, amorphous poly-alpha-olefins and a mixture thereof.

6. The process of claim 4, wherein the coating material is coated on the area in a manner of spraying, extruding, drenching or printing.

7. The process of claim 4, wherein the coating machine comprises at least one spraying head to spray the coating material on the area, the spraying head is adapted to heat the coating material to a boiling point of the low-boiling-point solvent so that the solvent can vaporize.

8. A process for coating a foamed coating material on a container or the like, comprising the following steps:
(a) heat blending or kneading a solid thermoplastic binder with a solid thermo-expandable powder consisting of a plurality of solid thermo-expandable microcapsules till the solid thermoplastic binder being gelatinized so that the thermo-expandable microcapsules being uniformly spread in the gelatinized thermoplastic binder to form a coating material, each thermo-expandable microcapsule consisting of a thermoplastic polymer shell and a low-boiling-point solvent wrapped by the thermoplastic polymer shell;
(b) coating the coating material on at least a part of an area specified on a continuous paper reel or a non-continuous paper sheet making up the container, or on at least a part of an area specified on an outer surface of the container by a coating machine;
(c) cooled down the coated continuous paper reel, the coated non-continuous paper sheet or the coated container to a room temperature for a storage purpose;
(d) heating the coated continuous paper reel, the coated non-continuous paper sheet or the coated container to a soften point of the binder so that the binder having slightly molecular flowability;
(e) further heating the coated continuous paper reel, the coated non-continuous paper sheet or the coated container to a boiling point of the low-boiling-point solvent so that the low-boiling-point solvent vaporizing to balloon the thermoplastic polymer shell, whereby the coating material is foamed and integrally attached on the coated continuous paper reel, the coated non-continuous paper sheet or the coated container.

9. The process of claim 8, wherein the binder is selected from a group consisting of ethylene vinyl acetate resin, polyurethane resin, polyacrylic acid resin, poly lactic acid, amorphous poly-alpha-olefins and a mixture thereof.

10. The process of claim 8, wherein the coating material is coated on the area in a manner of spraying, extruding, drenching or printing.
